(19) United States
(12) Patent Application Publication
(10) Pub. No.: US 2012/0254133 A1
(43) Pub. Date: Oct. 4, 2012

(54) METHOD FOR BINARY PERSISTENCE IN A SYSTEM PROVIDING OFFERS TO SUBSCRIBERS

(75) Inventors: Atzmon Hen-Tov, Kfar-Yona (IL); Eli Acherkan, Tel-Aviv (IL)

(73) Assignee: C/O PONTIS, LTD., Glil Yam (IL)

(21) Appl. No.: 13/429,776

(22) Filed: Mar. 26, 2012

Related U.S. Application Data
(60) Provisional application No. 61/468,092, filed on Mar. 28, 2011.

(51) Int. Cl. G06F 17/30

(52) U.S. Cl. 707/693; 707/687; 707/705; 707/E17.005; 707/E17.002

(57) ABSTRACT

A computerized method and system for binary persistence in a system providing offerings to subscribers of a service provider are provided. The method includes receiving a plurality of objects respective of offerings made to a subscriber of a service provider; serializing the plurality of objects beginning at an origin to generate a binary record; and storing the binary record in a binary field of an entry in a database, the entry being respective of the subscriber, wherein retrieval of the offerings made to the subscriber requires merely extraction of the binary record from the binary field and performing at least a partial deserialization thereon.

### CROSS-REFERENCE TO RELATED APPLICATIONS

This application claims priority from U.S. provisional application No. 61/468,092 filed Mar. 28, 2011, the contents of which are herein incorporated by reference.

### TECHNICAL FIELD

The invention generally relates to the processing of information stored in large databases, and more particularly to the processing of such information in an environment that is dynamically changing over time, including the model used with respect of the information stored in the database.

### BACKGROUND

In today's ever more competitive environment of providing subscribers with offers, and in particular the subscribers of telephony services, there is a need to effectively track the offers provided to the users to ensure that the users receive the promised benefits, as well as to remove a benefit if a user has not met the criteria. In addition it is necessary to continuously monitor the user's behavior on the system and address issues that may lead to the user's defection to another provider. In such systems a large number of transactions take place at any given point in time and it is desirable to be able to provide a response in as close as possible to real-time.

The systems are supported by relatively large database structures that are capable of handling the significant load thereon in general and in particular in peak hours. The offers to a subscriber are typically kept in the database and continuously monitored. There are many offers per subscriber, each offer having different terms and conditions that are to be met. For example, a subscriber may be required to perform a “top-up” at least five times a week of five US$ each time to qualify for a certain benefit, but may also have another offer of a “top-up” of at least ten US$ on each Monday and Thursday of the week. Another type of offer may be consumption of at least 150 minutes of calling time in a given period to receive a quantity of free minutes in another time period. Furthermore, all the offers can exist simultaneously and may enter and exit the billing system's database at any independent point in time which is not necessarily synchronized.

Typically, the solution to keep and monitor many offers per subscriber is to map into a relational database using a plurality of tables respective of the offers and states of the subscribers in all the offerings, so that when the processing of each takes place the user can enjoy the benefit. As noted above, an offer can be quite complex and may even be hierarchical and there are many structures that can occur. The subscriber may have the same structure for different offerings. For example, buy two ringtones and get one free as well as buy four games and get two free of some games. The structures are the same but the offerings are different and both need to be kept with respect of the subscriber having two different instances. This requires using and maintaining numerous databases' tables and there is a need to perform a join between the many tables, which is a daunting task as the number of offerings and number of subscribers increase. It is especially critical because of the need to respond in close to real-time when handling the case of an event that needs to respond synchronously to the subscriber.

In such systems that handle a large number of offerings to subscribers a large number of objects must be stored to and retrieved from a database in any given point in time. Once stored through a serialization method, retrieval requires deserialization that has a significant overhead. The serialization method converts a data structure or an object state into a storable format. Such a format may be a file, a database table, a packet, or other means that cause the data to be serialized. Then when the data is to be reconstructed, a deserialization process takes place to reconstruct the original data structure or object. The overhead results from the time needed for instantiation, the time necessary for the detection of changes in the binary, i.e., a dirty check, as well as the impact of garbage collection that is typically required and grows significantly as the number of objects grow.

It would be therefore advantageous to provide a solution that overcomes the deficiencies of the prior art.

### SUMMARY

Certain embodiments disclosed herein include a computerized method for binary persistence in a system providing offerings to subscribers of a service provider. The method comprises receiving a plurality of objects respective of offerings made to a subscriber of a service provider; serializing the plurality of objects beginning at an origin to generate a binary record; and storing the binary record in a binary field of an entry in a database, the entry being respective of the subscriber, wherein retrieval of the offerings made to the subscriber requires merely extraction of the binary record from the binary field and performing at least a partial deserialization thereon.

Certain embodiments disclosed herein also include a computerized method for efficient retrieval of offerings from a system providing offerings to subscribers of a service provider. The method comprises maintaining a binary representation respective of a plurality of offerings made to a subscriber of a service provider; upon receiving a request to retrieve one or more offerings of the plurality of offerings made to the subscriber, extracting of a binary record that includes the a binary representation; and performing at least a partial deserialization of the binary record.

Certain embodiments disclosed herein also include an apparatus for binary persistence in a system providing offerings to subscribers of a service provider. The apparatus comprises a database comprising at least an entry corresponding to a subscriber of the service provider, the entry having a binary field; and a processor connected to the database for processing a plurality of objects respective of offerings made to the subscriber of the service provider, serializing the plurality of objects beginning at an origin to generate a binary record, and storing the binary record in the binary field of the entry in the database; wherein retrieval of the offerings made to the subscribers requires merely the extraction of the binary record from the binary field and performing at least a partial deserialization thereon.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention will be apparent from the following detailed description taken in conjunction with the accompanying drawings.

FIG. 1 is a flowchart depicting the storage of objects respective of offerings made to a subscriber in accordance with an embodiment of the invention.

FIG. 2 is a flowchart depicting the deserialization process in accordance with an embodiment of the invention.

FIG. 3 is a flowchart depicting the compression process of the content directed to a binary field in accordance with an embodiment of the invention.

FIG. 4 is a flowchart depicting the access to a binary field in accordance with an embodiment of the invention.

FIG. 5 is a flowchart depicting the update of a binary field in accordance with an embodiment of the invention.

### DETAILED DESCRIPTION

The embodiments disclosed herein are only examples of the many possible advantageous uses and implementations of the innovative teachings presented herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

In a billing or offerings system requiring the processing of events there is a need to use information regarding a subscriber as well as a join of a plurality of other entities to understand the offerings given to the subscriber by a service provider. It should be noted that while offerings are described herein in greater detail, the teachings with respect of the offerings should not be viewed as limiting the scope of the invention. The service provider may be for example, a cellular carrier, a cable company, an Internet service provider, and the like. As a result, there is a need to perform many read/write operations on the database that stores the various offerings associated with each subscriber, which slows the overall response. An approach that enables the extraction of one record from the database and at most one record being updated is used. The record allows storage and retrieval of data by a unique identifier without knowledge of the application of the data. The one record contains a binary large object of the database and contains all the objects needed for the processing. The format is adapted to enable evolution of the system's dynamic model where offerings continuously change over relatively short periods of time.

In accordance with certain embodiments disclosed herein, instead of creating multiple tables as used in the prior art, the information about all the offerings, including all of the variations thereof, is kept as a large binary container, a form of a compound binary format (CBF), that is kept in a single record of the subscribers table. This solves the need to read multiple tables every time there is an event that relates to a subscriber. In fact, only a single row is read where one or more columns of the row is the binary of the offerings that contains all that is needed for handling the offerings for a particular subscriber.

The binary container maintains a plurality of objects, for example Java objects, that are then executed. It should be understood that a container allows its clients, which are the likes of offerings, benefits, etc., to store arbitrary subscriber-related data, without specific knowledge of its content. That is, a client is an entity that can use data in the binary container. A client can be, for example, offers that are defined by a user of the system and that can access the data container for information. The data supply by the clients includes a unique identifier, which is kept consistent between requests, so that each client can retrieve its corresponding data by the use of this unique identifier. The entire graph of objects containing multiple objects (hundreds, thousands or tens of thousands), organized as a tree having an origin, are mapped to a single or multiple columns in the subscriber's table in a binary form.

The binary form is generated using a serialization process provided according to one embodiment of the invention and described in more detail herein below. The disclosed serialization process would improve the retrieval of the objects and the cost associated in fetching, instantiating, dirty-checking and garbage-collecting objects. In a typical application, this structure significantly reduces access time to the subscriber's information from hundreds of milliseconds to a few milliseconds.

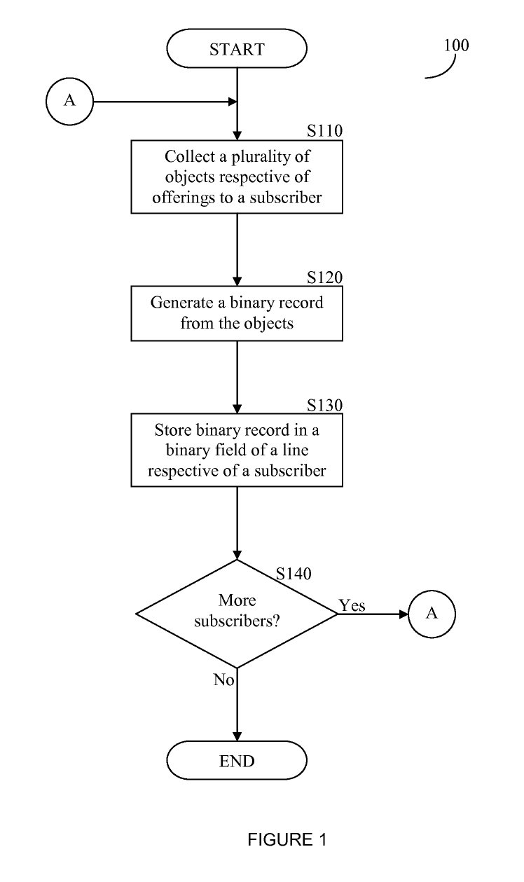

FIG. 1 depicts an exemplary and non-limiting flowchart 100 of the storage of objects respective of offerings made to a subscriber in accordance with an embodiment of the invention. In S110, the plurality of objects related to the offerings made to a subscriber are collected for the purpose of preparation of the binary container. In S120, a binary representation of the objects is generated through a serialization process that is described in more detail herein below. The binary representation is a flat map in which clients deposit elements that have a back-pointer to their client (or sub-component thereof) using a unique identifier. In S130, the binary representation is stored in a record of a row in the database that is respective of the subscriber. This allows at retrieval time access to all the objects respective of the subscriber's offering in a single access to the database thereby overcoming some of the deficiencies of the prior art solutions. Optionally, in S140 it is checked whether additional subscribers are to be added to the database in the same manner, and if so execution continues with S110; otherwise, execution terminates.

Prior art solutions assume that the classes created by the programmer are static and do not change during the operation of the system. This prevents the use of a standard serialization that cannot work in an ever changing model as required in accordance with the principles of the invention, as classes may change. The serialization/deserialization processes (or serializer/deserializer) in accordance with the embodiments disclosed herein can operate in an ever changing model environment of the solution.

For example, and without limitation, the model according to one embodiment changes dynamically and a class that may have three properties A, B and C at one point is serialized in that manner. At a later time, the model may change to have four properties, A, B, C, and D which can also be serialized. The challenge is to deserialize correctly so that the earlier object is deserialized with the interface elements A, B, and C while the later object is deserialized with A, B, C and D. The deserializer recognizes the attempt to deserialize an earlier version and provides an adaptor to handle the earlier version appropriately. In another example, the change of the interface elements may be for interface element C to be a string instead of a number. The deserializer recognizes that there was a change in the model and an appropriate utility supplied for the conversion is used to adapt the previously stored binary to the current operating model. It should be noted that this functionality is made possible by means of an external description of the model and a corresponding management version identifier at the instance level.

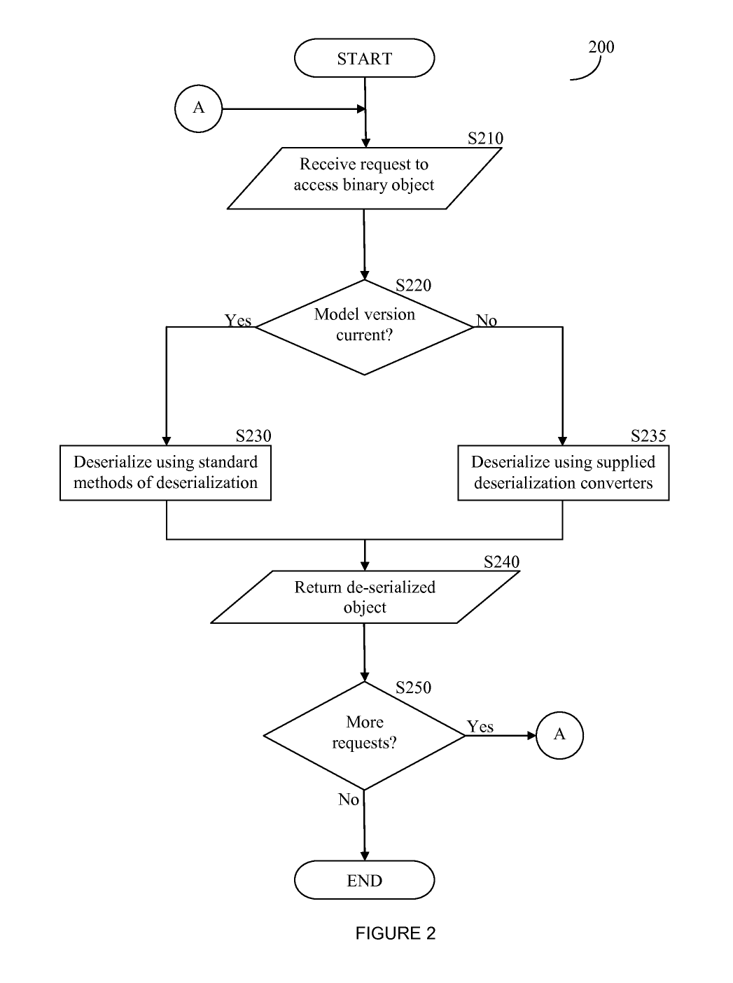

FIG. 2 shows an exemplary and non-limiting flowchart 200 of the deserialization process in accordance with one embodiment. In S210, a request is received to access a binary object (representation), where a binary object is an object within a binary record, in a row respective of a subscriber. In S220, it is checked if the model version of the stored binary object is the current model version, and if so execution continues with S230 where deserialization is performed using either standard deserialization, or otherwise an on-demand deserialization as explained in more detail herein below; otherwise, execution continues with S235 where the objects that have changed in the newer model are handled by deserializing converters to enable the handling of the older version. One or more converters are provided to handle objects of an older model that are required due to changes made in the newer model. Execution then continues with S240 where the deserialized objects are returned, or otherwise stored in memory for execution purposes. In S250, it is checked whether additional requests are to be handled, and if so execution continues with S210; otherwise, execution terminates. It should be further noted that this allows online upgrade support as there is always a way to handle objects of an older model in newer versions of the system.

Typically, a binary record is limited in the size that it can store. For example, Oracle® limits the size of the binary record stored in line to be no more than 4 KB and if a larger size is to be stored then the database program essentially directs the data to a different storage location. While transparent to the user of the database, such behavior leads to a significantly reduced performance as the consequence of the redirection and the size of the larger binary record. The impact on retrieval and storage time can be such that a 10× to 20× performance degradation may be observed. Therefore, in accordance with an embodiment of the invention, prior to storage of the binary data, the size of the record is checked and if it is above a predetermined threshold, for example 4 KB, a compression is applied on the binary data.

The compression may be performed using commonly available compression schemes, such as but not limited to Zip®, thus more data can be stored in the record. Typically, a record of 26 KB can be compressed into a 4 KB for storage in the binary field. Of course, when such a compression takes place it is necessary to decompress the binary record prior to the handling of the binary data. For example, and without limitation, in FIG. 2, a step can be added between S210 and S220 that checks if the content of the binary field was compressed, and if so, uncompresses that content to generate the binary field.

While in a typical system a 26 KB binary data should be ample, it is foreseeable that larger sizes may be needed. In such a case, at least another binary field may be used for splitting the data between the two records in the same line (entry) associated with the subscriber. This way the solution can store larger binary representation of objects, while maintaining the solution's advantage of one read and one write at the most with respect to access information of a respective subscriber. The binary representation typically starts with a Boolean marker, denoting whether the rest of the data is compressed.

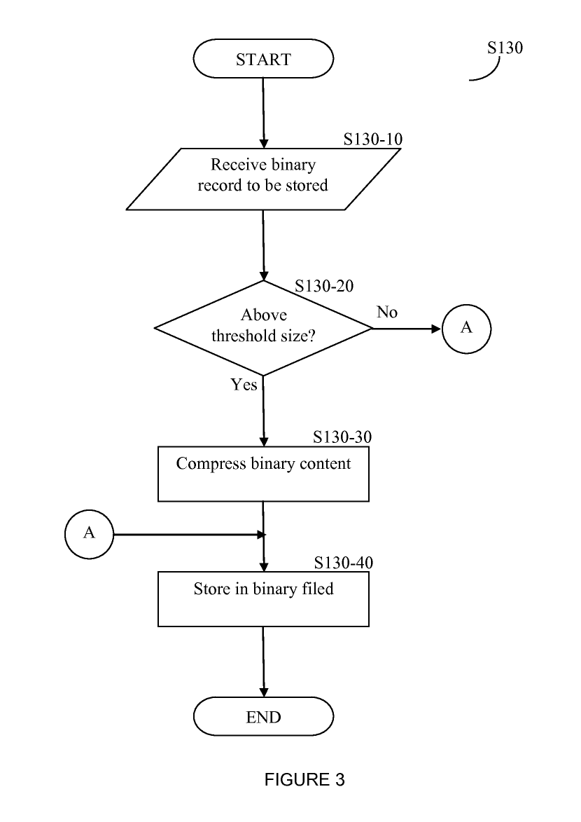

FIG. 3 depicts an exemplary and non-limiting flowchart S130 for storing a binary record directed to a binary field when compression is needed. In S130-10, a binary record is received for storage in the binary field. In S130-20, the size of the binary record is checked, and if it exceeds a threshold value execution continues with S130-30; otherwise, execution continues with S130-40. The threshold value is a parameter of the database in which the binary record should be stored. In S130-30, the binary record is compressed using for example, and without limitation, a standard compression algorithm such as Zip®. In S130-40, the binary record is stored in the binary field of the appropriate entry associated with the subscriber.

The binary representation in the binary field, as noted above, contains at all times all the offerings made with respect to a subscriber along with their respective state. Therefore, such a binary content will tend to grow over time as more offerings are added with respect to a subscriber. However, some of the offerings expire over time. In accordance with one embodiment, when an event takes place that results in change in the binary of a subscriber, a cleaning process takes place.

In one embodiment, the cleaning process removes from the binary content the offerings that are no longer relevant. Doing it in this manner is advantageous over cleaning processes that take place as batch programs that require significant resources and handle each and every record whether necessary or not. Handling the binary content when it is actually being processed for other reasons, allows for continuous cleaning processes and maintaining the size of the binary content under constant control.

In an embodiment, the binary representation stored in the binary field for the user has a structure that is particularly useful for efficient serialization and deserialization of the binary content respective of a user. The binary representation has in fact three sections, a header section, a map section, and a binary section. The header section contains general information about the binary representation such as compression, version, header size, number of entries and the like. The map section has a list of an identification, or key, which is unique to each client and the offset of the binary section that contains the objects for that specific client. For example, for ID=123, the offset maybe ‘0’ meaning that it starts at address ‘0’ of the binary section, and for ID=456 the offset maybe ‘60’ meaning that it starts at address ‘60’ of the binary section.

The binary section itself contains the binary representation as described in greater detail hereinabove. When a certain offer needs to read a section of the data according to a given key, first the map section is checked, and if no match is found then there is no need to perform any kind of deserialization. If a match is found, then only the necessary portion needs to be deserialized thereby avoiding the need to deserialize and activate multiple objects that will not ever be used in the processing of the event. Overall the performance of the offerings system is significantly improved by avoiding such unnecessary deserializtion or confining the deserialization to only those portions that are needed for the specific processing. This further prevents the need to perform significant garbage cleaning of objects that were instantiated but never used.

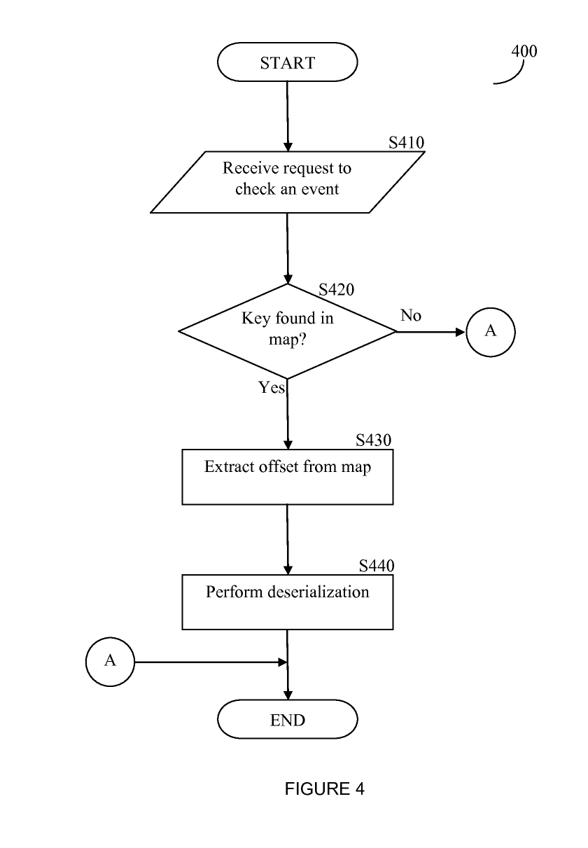

FIG. 4 shows an exemplary and non-limiting flowchart 400 depicting the access to a binary record in accordance with one embodiment. In S410, there is a request to access a binary field by a specific event. In S420, it is checked whether the unique identification of the offer appears in the map section of the binary content, and if so execution continues with S430; otherwise, deserialization terminates. In S430 an offset is extracted from the map respective of the event, the offset being the location from which the deserialization is to begin. In S440, deserialization from the offset point begins, for example, according to the deserialization process discussed with respect of FIG. 2 hereinabove, after which execution terminates.

Once the offset is open it is necessary to know if there is a need to replace the binary representation due to a change done as part of the execution. In prior art solutions, the entire binary would have to undergo comparison with the value read from the DB and then be serialized from the beginning. However, as in accordance with the invention as discussed hereinabove, only the portions of the binary representation that were deserialized are necessary to check for changes, and only those that were changed need to undergo serialization. The entire binary representation is recomposed from the newly serialized binary parts and the parts that were not deserialized. The advantage is that in most cases the checking is limited to a very small portion of the entire binary content, and even if changes are found, not the entire binary needs to be serialized but only the portions found to be changed as well as an update of the map.

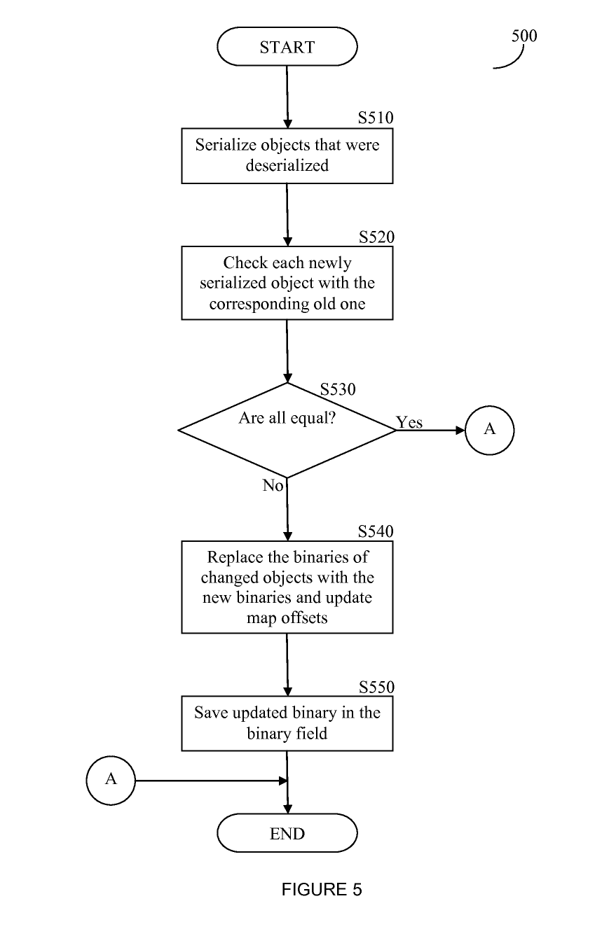

FIG. 5 depicts an exemplary and non-limiting flowchart 500 of the update of a binary field in accordance with one embodiment. In S510, the objects that were previously deserialized as explained hereinabove are serialized. As mentioned above, a serialization process converts a data structure or an object state into a storable format.

In S520 each newly serialized object is checked with the corresponding binary previously extracted. In S530, it is checked if all are equal, and if so execution terminates; otherwise, execution continues with S540 where serialized objects found to be different from the originating binaries replace the originating binaries, and the map is updated with the new corresponding offset value. In S550, the new binary record is saved in the binary field of the line (or entry) corresponding to the subscriber. As noted above the use of this method significantly reduces the overhead related to the serialization of the binary into the binary field by restricting the operations to only accessed objects rather than the entire content.

In one embodiment, it is desirable to minimize the size of the binary content. For that purpose, unique identifications for the model elements are represented by their hash signature instead of a full textual identification. The hash code requires only four bytes, thus saving a considerable amount of space. Using the hash code instead of a separately generated index ensures consistency over time and resilience to model evolution. An additional mechanism is used to prevent collisions of hash codes. In yet another embodiment, each string object is assigned a numeric index on a per-serialization basis, and consecutive appearances of the same string are represented by this index only, saving the need to repeat string objects in the same binary object.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

A database may comprise a single database or a plurality of databases that may be further distributed and communicatively connected by means of, for example and without limitation, a network. Such a network may be a local area network (LAN), a wide area network (WAN), a metro area network (MAN), the Internet, the worldwide web (WWW), and other wired and wireless networks.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A computerized method for binary persistence in a system providing offerings to subscribers of a service provider, comprising:
receiving a plurality of objects respective of offerings made to a subscriber of a service provider;
serializing the plurality of objects beginning at an origin to generate a binary record; and
storing the binary record in a binary field of an entry in a database, the entry being respective of the subscriber, wherein retrieval of the offerings made to the subscriber requires merely extraction of the binary record from the binary field and performing at least a partial deserialization thereon.

2. The computerized method of claim 1, further comprising:
determining a binary size of the binary record and if the binary size is above a threshold value performing a compression of the binary record.

3. The computerized method of claim 1, wherein generating the binary record comprises:
generating a binary record header;
generating a binary record offset map; and
generating a binary content respective of at least a portion of the plurality of objects at offset locations corresponding to the offset map.

4. The computerized method of claim 3, wherein the header contains at least a model version.

5. The computerized method of claim 4, further comprising:
receiving a request to extract a binary object from the binary record;
checking the header to determine if a binary object model version corresponds to a current model version;
directly deserializing the binary object if the binary object model version corresponds to the current model version; and
using at least a converter to handle at least a portion of the binary record, the at least a converter corresponding to a model version which is not the current model version.

6. The computerized method of claim 3, further comprising:
receiving a request to extract a binary object from the binary record corresponding to an event having a unique identification;
checking if the unique identification exists in the offset map; and
performing deserialization from the offset in the offset map that corresponds to the unique identification, if the unique identification exists in the offset map.

7. The computerized method of claim 6, further comprising:
serializing each deserialized object;
checking each newly serialized object with a corresponding previously serialized object;
determining if all the newly serialized objects are equal to the previously serialized objects; and
replacing each previously changed serialized object with a corresponding newly serialized object and updating the offset map accordingly if the newly serialized objects are not equal to the previously serialized objects.

8. The computerized method of claim 1, further comprising:
clearing periodically from the binary record at least one object respective of offerings for offerings that are no longer relevant.

9. A non-transitory computer readable medium having stored thereon instructions for causing one or more processing units to execute a method of claim 1.

10. A computerized method for efficient retrieval of offerings from a system providing offerings to subscribers of a service provider, comprising:
maintaining a binary representation respective of a plurality of offerings made to a subscriber of a service provider;
upon receiving a request to retrieve one or more offerings of the plurality of offerings made to the subscriber, extracting of a binary record that includes the a binary representation; and
performing at least a partial deserialization of the binary record.

11. The computerized method of claim 10, wherein maintaining the binary representation further comprising:
serializing a plurality of objects respective of the plurality of offerings beginning at an origin to generate the binary record; and
storing the binary record in a binary field of an entry in a database, the entry being respective of the subscriber.

12. The computerized method of claim 11, wherein generating the binary record comprises:
generating a binary record header;
generating a binary record offset map; and
generating a binary content respective of at least a portion of the plurality of objects at offset locations corresponding to the offset map.

13. The computerized method of claim 12, wherein the header contains at least a model version.

14. The computerized method of claim 13, wherein upon receiving a request to retrieve further comprising:
receiving a request to extract a binary object from the binary record;
checking the header to determine if a binary object model version corresponds to the current model version;
directly deserializing the binary object if the binary record model version corresponds to the current model version; and
using at least a converter to handle at least a portion of the binary record that cannot be deserialized according to the current model version, the at least a converter corresponding to a model version which is not the current model version.

15. The computerized method of claim 14, further comprising:
receiving a request to extract a binary object from the binary record corresponding to an event having a unique identification;
checking if the unique identification exists in the offset map; and
performing deserialization from the offset in the offset map that corresponds to the unique identification, if the unique identification exists in the offset map.

16. The computerized method of claim 15, further comprising:
serializing each deserialized object;
checking each newly serialized object with a corresponding previously serialized object;
determining if all the newly serialized objects are equal to the previously serialized objects; and
replacing each changed previously serialized object with a corresponding newly serialized object and updating the offset map accordingly, if the newly serialized objects are not equal to the previously serialized objects.

17. The computerized method of claim 10, further comprising:
clearing periodically from the binary record at least one object respective of offerings for offerings that are no longer relevant.

18. A non-transitory computer readable medium having stored thereon instructions for causing one or more processing units to execute a method of claim 10.

19. An apparatus for binary persistence in a system providing offerings to subscribers of a service provider, comprising:
a database comprising at least an entry corresponding to a subscriber of the service provider, the entry having a binary field; and
a processor connected to the database for processing a plurality of objects respective of offerings made to the subscriber of the service provider, serializing the plurality of objects beginning at an origin to generate a binary record, and storing the binary record in the binary field of the entry in the database;
wherein retrieval of the offerings made to the subscribers requires merely the extraction of the binary record from the binary field and performing at least a partial deserialization thereon.

20. The apparatus of claim 19, wherein the processor is configured to determine a binary size of the binary record, and if the binary size is above a threshold value the processor is configured to perform a compression of the binary record.

21. The apparatus of claim 19, wherein the processor is further configured to:
receive a request to extract the binary object from the binary record and check a header of the binary record to determine if a binary object model version corresponds to a current model version;
directly deserializes at least a portion of the binary record if the binary object model version corresponds to the current model version; and
execute at least a converter program to handle at least a portion of the binary record, the least converter program corresponding to a model version that is not the current model version.

22. The apparatus of claim 19, wherein the processor is further configured to:
receive a request to extract a binary object from the binary record corresponding to an event and having a unique identification;
check if the unique identification exists in the offset map; and
perform deserialization from the offset in the offset map that corresponds to the unique identification, if the unique identification exists in the offset map.

23. The apparatus of claim 19, wherein the processor is further configured to serialize each deserialized object, check each newly serialized object with a corresponding previously serialized object, and determine if all the newly serialized objects are equal to the previously serialized objects, and to replace each previously changed serialized object with a corresponding newly serialized object and update the offset map accordingly if the newly serialized objects are not equal to the previously serialized objects.

24. The apparatus of claim 19, wherein the processor is further configured to:
periodically clear from the binary record at least one object respective of offerings for offerings that are no longer relevant.
